(19) United States
(12) Patent Application Publication
(10) Pub. No.: US 2024/0140859 A1
(43) Pub. Date: May 2, 2024

(54) PERIPHERAL OVERFILLED-SPILLAGE-PROTECTED CERAMIC COOKTOP

(71) Applicant: Whirlpool Corporation, Benton Harbor, MI (US)

(72) Inventors: Alexandre Machado BARDAL, St. Joseph, MI (US); Muhammad Khizar, St. Joseph, MI (US)

(73) Assignee: Whirlpool Corporation, Benton Harbor, MI (US)

(21) Appl. No.: 18/410,689

(22) Filed: Jan. 11, 2024

Related U.S. Application Data
(62) Division of application No. 17/138,449, filed on Dec. 30, 2020.

(51) Int. Cl. C03C 17/22; C03C 17/00; C03C 19/00

(52) U.S. Cl. CPC C03C 17/22; C03C 17/002; C03C 17/009; C03C 19/00; B82Y 30/00; C03C 2217/76

(57) ABSTRACT

A panel is provided. The panel includes a substrate having a top surface and a liquid-repelling element disposed on the top surface as a single line free of parallel sublines, the single line defining a geometric pattern. The liquid-repelling element comprises graphene nanoparticles.

### CROSS-REFERENCE TO RELATED APPLICATIONS

This application is a divisional of U.S. patent application Ser. No. 17/138,449 filed on Dec. 30, 2020. The entire disclosure of the above application is incorporated herein by reference.

### BACKGROUND

This section provides background information related to the present disclosure which is not necessarily prior art.

Freestanding cooking appliances are typically installed in close proximity to kitchen worktops, e.g., counters, floors, and furniture, that often are made of materials, such as wood, stone, quartz, and marble, which are sensitive to heat and/or humidity and easily stainable. When liquids spill out of cookware or other utensils onto cooktops, the cooktops are unable to retain them such that contact between the liquids and surrounding worktops, floors, or furniture can be avoided. As a consequence, liquids often flow onto and contact worktops, floors, and furniture, which absorb the liquids and may become permanently stained and/or otherwise damaged. These issues are also present in cooking appliances that are “built-in” or installed flush with a surrounding worktop, countertop, or island surface. Therefore, it would be beneficial for cooking appliances to be capable of trapping or slowing spills so that they can be cleaned before surrounding worktops, floors, or furniture are damaged.

### SUMMARY

This section provides a general summary of the disclosure, and is not a comprehensive disclosure of its full scope or all of its features.

The present disclosure relates to a peripheral overfilled-spillage-protected ceramic cooktop.

In various aspects, the current technology provides a panel including a substrate having a top surface and a liquid-repelling element disposed on the top surface as a single line free of parallel sublines, the single line defining a geometric pattern, wherein the liquid-repelling element includes graphene nanoparticles.

In one aspect, the substrate is a glass, a ceramic, or a glass ceramic.

In one aspect, the graphene nanoparticles include less than or equal to about ten layers of graphene.

In one aspect, at least a portion of the graphene nanoparticles include a single sheet of graphene.

In one aspect, the liquid-repelling element further includes a polymeric matrix that carries the graphene nanoparticles.

In one aspect, the liquid-repelling element is superhydrophobic.

In one aspect, the liquid-repelling element exhibits a water sliding angle of less than or equal to about 5°.

In one aspect, the geometric pattern is a continuous pattern defining a circle, an oval, or a polygon.

In one aspect, the continuous pattern is disposed about a periphery of the substrate.

In one aspect, the panel has a plurality of liquid-repelling elements.

In one aspect, the panel defines a cooktop surface.

In various aspects, the current technology also provides a panel including a substrate having a top surface and a liquid-repelling element disposed directly on the top surface as a single line free of parallel sublines and sublayers, the single line defining a geometric pattern, wherein the liquid-repelling element: includes graphene nanoparticles embedded within a polymeric matrix, exhibits a water contact angle of greater than or equal to about 160°, exhibits a water sliding angle of less than or equal to about 3°, and prevents, slows, or minimizes liquids from flowing off of the panel.

In one aspect, the substrate further has at least one heating element region.

In one aspect, the liquid-repelling element defines a frame that extends about the periphery of the substrate, wherein the surface of the substrate is exposed in a region within the frame.

In various aspects, the current technology also provides a cooking appliance including the panel as a cooktop.

In one aspect, the cooktop is a gas cooktop, an electric cooktop, or an induction cooktop.

In various aspects, the current technology further provides a method of fabricating a panel, the method including disposing a precursor solution directly onto a surface of a substrate in a pattern defined by a single line, the precursor solution including a polymer precursor and graphene nanoparticles; heating the substrate and the precursor solution; creating a liquid-repelling film including the graphene nanoparticles embedded within a polymeric matrix derived from the polymer precursor, the liquid-repelling film having the pattern from the precursor solution on the surface of the substrate; and forming the panel, wherein the liquid-repelling film exhibits a water contact angle of greater than or equal to about 160° and a water sliding angle of less than or equal to about 3°.

In one aspect, the pattern is a frame that extends about the periphery of the substrate.

In one aspect, the substrate has at least one heating element region.

In one aspect, the method further includes incorporating the panel into a cooking appliance.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 is an illustration of a panel in accordance with various aspects of the current technology.

FIGS. 2A-2C are illustrations of liquid-repelling elements, in which a single line has a subline (FIG. 2A), a single curved line has a subline (FIG. 2B), and individual single lines are not sublines of each other (FIG. 2C) in accordance with various aspects of the current technology.

FIGS. 3A and 3B are illustrations of panels having liquid-repelling elements that define continuous geometric patterns in accordance with various aspects of the current technology. The panel of FIG. 3B additionally includes a liquid-repelling element that defines a discontinuous geometric pattern in accordance with various other aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

When liquids, including hot liquids, are spilled onto surfaces of cooktops, the liquids may contact, stain, or otherwise damage adjacent worktops, floors, or furniture. Accordingly, the current technology provides cooktops having liquid-directing and/or liquid-containing elements that slow, minimize, or prevent the spilled liquids from flowing off of cooktops. As a result, a user is capable of cleaning liquid spills before the adjacent worktops, floor, or furniture are stained or damaged.

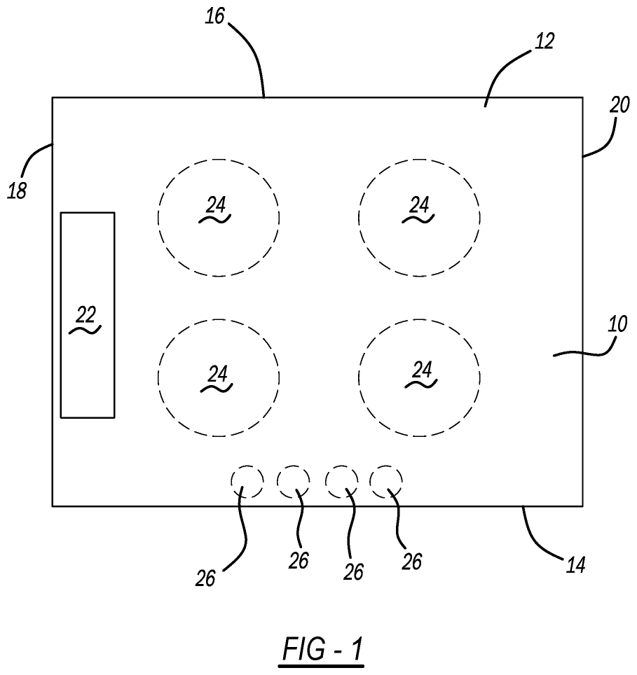

With reference to FIG. 1, the current technology provides a panel 10 having a top surface 12, a front edge 14, a rear edge 16, a left edge 18, and a right edge 20. At least one liquid-repelling element 22 is disposed on the top surface 12. The panel 10 can be incorporated into an appliance that benefits from slowing, minimizing, or preventing liquid spills from flowing off of the panel 10. In certain aspects, the appliance is a cooking appliance, such as a range, a rangetop, or a stovetop, each of which can be freestanding or built into surrounding architecture. More particularly, the panel 10 is incorporated into the cooking appliance as a cooktop so that at least portions of the top surface 12 of the panel 10 are exposed to an external environment. As a component of a cooking appliance, the panel 10 can include at least one heating element region 24 (although four heating element regions 24 are shown in FIG. 1). The at least one heating element region 24 can accommodate or house, for example, an electric burner or a gas burner or be a surface above an electromagnet and coil for induction heating. In some aspects, the panel 10 can also include at least one control element 26 (although four control elements 26 are shown in FIG. 1), such as a knob and/or a button, for controlling the amount of heat provided from the at least one heating element region 24. However, the at least one control element 26 can alternatively be located on a side edge of the panel 10 or on a different surface of the cooking appliance. It is understood that the positional configurations of the at least one heating element region 24 and the at least one control element 26 are independently exemplary and non-limiting and that alternative positional configurations can be employed. Although the panel 10 is shown in a rectangular shape, it is understood that the shape is non-limiting.

The panel 10 is defined by a substrate comprising a glass, a ceramic, or a glass ceramic material. As such, the panel 10 may also be referred to herein as a “glass panel,” a “ceramic panel,” or a “glass ceramic panel.” As is known in the art, glass ceramic materials have an amorphous (glassy) phase and at least one crystalline (ceramic) phase embedded within the amorphous phase. Glass ceramic materials can be fabricated by, for example, subjecting a glass material to a heat treatment that controls glass nucleation and crystallization. Therefore, relative amounts of amorphous and crystalline phases can be controlled at least partially through the heat treatment. As the amount of crystalline phases increases, grain boundaries also increase, and the glass ceramic material transitions from being visibly transparent to opaque. The high strength, high impact resistance, low co-efficient of thermal expansion, and aesthetic optical properties of glass ceramic materials make them particularly suited for cooktops.

The glass ceramic material can be an oxide material or a non-oxide material. Whereas oxide materials include at least one oxide, such as silicon dioxide (SiO₂; “silicate”), boron trioxide (B₂O₃; “borate”), phosphorus pentoxide (P₂O₅; “phosphate”), or germanium dioxide (GeO₂; “germinate”), non-oxide materials include a chalcogenide (group 16 element), such as sulfur (S), selenium (Se), tellurium (Te), polonium (Po), or combinations thereof, for example, as sulfides, selenides, tellurides, and/or polonides, and optionally at least one of a halide or metal. Non-limiting examples of oxide glass ceramics include Li₂O—Al₂O₃—SiO₂ (LAS), which is a mixture of lithium, aluminum, and silicon oxides with glass forming agents, such as sodium oxide (Na₂O), potassium oxide (K₂O), or calcium oxide (CaO); MgO—Al₂O₃—SiO₂ (MAS), which is a mixture of magnesium, aluminum, and silicon oxides with glass forming agents; ZnO—Al₂O₃—SiO₂ (ZAS), which is a mixture of zinc, aluminum, and silicon oxides with glass forming agents; derivatives thereof; and combinations thereof. The glass ceramic material is non-hydrophobic, i.e., it exhibits a water contact angle of less than or equal to about 90°.

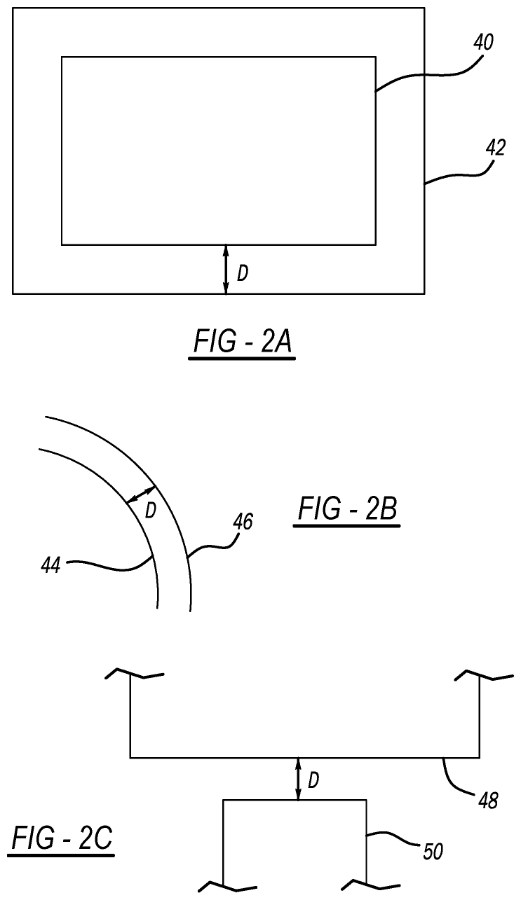

The at least one liquid-repelling element 22, or each liquid-repelling element 22 of a plurality, comprises a film disposed on the top surface 12 of the panel 10 as a single line that defines a geometric pattern. By a “single line,” it is meant that the film is substantially two-dimensional, due to the height being very small (as discussed in more detail below), and is free of parallel or concentric sublines, where “parallel or concentric sublines” are lines that follow substantially the entire path of the single line, but are separated from the single line by a distance of greater than or equal to about 500 μm to less than or equal to about 2.5 cm. Lines that follow substantially the same shape are lines that define the same final shape as a whole with a variance of less than or equal to about 80%, other than scale. For example, FIG. 2A shows a single straight line 40 and a subline 42 that runs parallel to the single straight line 40 and is separated from the single straight line 40 by the distance D, and FIG. 2B shows a single curved line 44 and a subline 46 that runs concentric to the single curved line 44 and is separated from the single curved line 44 by the distance D. In contrast, FIG. 2C shows a first single straight line 48 and a second single straight line 50 that runs parallel to only a portion of the first single straight line 48. Even though the first single straight line 48 and the second single straight line 50 are separated by a distance D at a portion where the first and second straight lines 48, 50 are parallel to each other, neither the first single straight line 48 nor the second single straight line 50 is a subline of the other because they are not substantially the same shape as a whole.

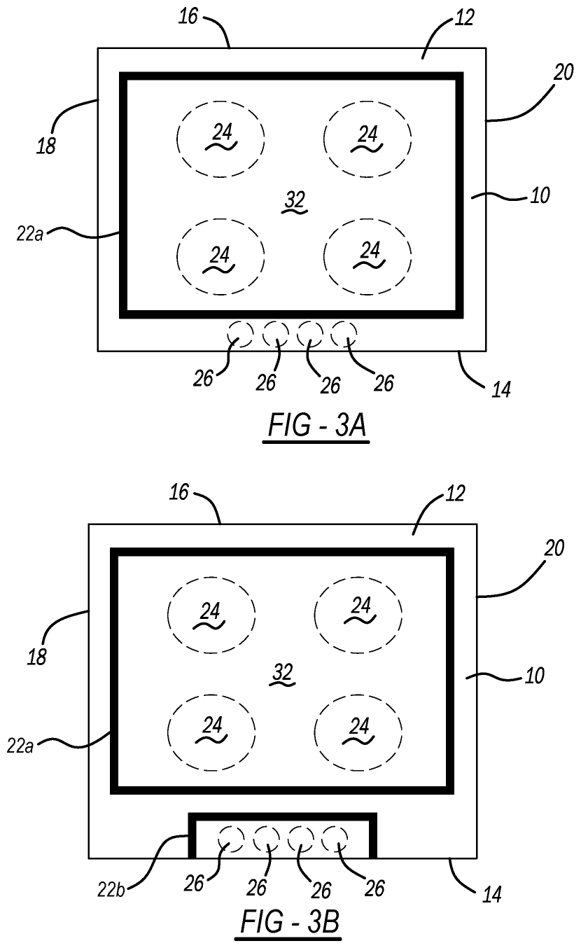

Referring back to FIG. 1, the at least one liquid-repelling element 22 is disposed directly on the top surface 12 of the panel 10 as a single line defining a geometric pattern. The single line can be straight or curved, and the geometric pattern is non-limiting. For example, the single line can be a continuous single line that defines a complete enclosure, such as circle, an oval, an egg-shape, or a polygon (e.g., rectangle, square, pentagon, hexagon, trapezoid, diamond, and the like), or the single line can be a discontinuous single line having distinct end points. As a non-limiting example, FIG. 3A shows the panel 10 of FIG. 1 having a liquid-repelling element 22a disposed thereon, wherein the liquid-repelling element 22a is a film comprising a single straight line that defines a continuous geometric pattern, i.e., a rectangle, extending about the periphery of the panel 10 as a frame. When present, the at least one heating element region 24 is located in a central region 32 defined or framed by the rectangle. In another example shown in FIG. 3B, the panel 10 includes the liquid-repelling element 22a of FIG. 3A and additionally includes a second liquid-repelling element 22b in a discontinuous geometric pattern, i.e., having distinct ends that terminate at the front edge 14, wherein the second liquid-repelling element 22b encloses the optional at least one control element 26. It is understood that the geometric patterns defined by the single line are not limiting and can be any continuous and/or discontinuous pattern.

The film comprises a film material comprising graphene nanoparticles or nanosheets embedded within, i.e., carried by, a polymeric matrix at a concentration of greater than or equal to about 0.5 wt. % to less than or equal to about 10 wt. % or greater than or equal to about 1 wt. % to less than or equal to about 7.5 wt. %, e.g., about 0.5 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, or about 10 wt. %. The graphene can be a monolayer two-dimensional sheet, i.e., single atom thick, of carbon atoms in a hexagonally arranged honeycomb lattice, or few-layer graphene having greater than or equal to two graphene layers to less than or equal to about ten graphene layers. Accordingly, the graphene nanoparticles can have less than or equal to about ten layers of graphene. In some aspects, the graphene is a graphene derivative, such as graphene oxide or reduced graphene oxide, as non-limiting examples. The graphene nanoparticles or nanosheets have a diameter of greater than or equal to about 1 nm to less than or equal to about 500 nm, greater than or equal to about 1 nm to less than or equal to about 250 nm, greater than or equal to about 1 nm to less than or equal to about 100 nm, greater than or equal to about 1 nm to less than or equal to about 50 nm, or greater than or equal to about 1 nm to less than or equal to about 25 nm. The polymeric matrix comprises a thermoplastic polymer, such as polymethyl methacrylate/methyl methacrylate (PMMA/MMA) resins or polyolefins generated by an olefin polymerization catalyst system including a solid catalyst, as non-limiting examples. Suitable catalysts for the olefin polymerization catalyst system are known in the art and include Ziegler-Natta catalysts, i.e., transition metal halide or oxide or oxo-halide with an alkylating co-catalyst (e.g., alkyl aluminum), including TiCl₄/MgCl₂/AlEt₃, CrO₃/Al₂O₃/AlEt₃, and VOCl₃/AlEt₃; high valent transition metal complexes in combination with methylalumoxane ([MeAlO]n, MAO, a hydrolysis product of AlMe₃), including Et(Ind)₂ZrCl₂/MAO (isotactic polypropylene) and Pr(Cp)(FIr)ZrCl₂/MAO (syndiotactic polypropylene); and cationic homogeneous catalysts with weakly coordinating anions, including Cp′2ZrMe₂, with oxidizing tetraphenylborate salts, including AgBPh₄ and (Cp₂Fe)BPh₄. In certain aspects, the film material consists essentially of or consists of the graphene nanoparticles or nanosheets and the polymeric matrix. By “consists essentially of,” it is meant that the film material does not intentionally include additional components, but may include additional components as unavoidable impurities at individual impurity concentrations of less than or equal to about 5 wt. % based on the total weight of the film material. In other aspects, the film comprises the film material as a single homogenous layer and is free of sublayers, such as top layers or adhesive layers.

The film material, and thus the at least one liquid-repelling element 22, is superhydrophobic, exhibiting a water contact angle of greater than or equal to about 140°, greater than or equal to about 150°, greater than or equal to about 160°, or greater than or equal to about 162°. The water contact angle exhibited by the film material is greater than a second water contact angle exhibited by the substrate. The at least one liquid-repelling element 22 also exhibits a water sliding angle, i.e., a minimum angle of inclination at which a water droplet starts to roll off the top surface 12, of less than or equal to about 10°, less than or equal to about 5°, or less than or equal to about 3°. As such, the at least one liquid-repelling element 22 has a different surface energy than exposed top surfaces 12 of the panel 10 that are not covered by the at least one liquid-repelling element 22. Therefore, the at least one liquid-repelling element 22 is capable of trapping, containing, or holding spilled liquids when the at least one liquid-repelling element 22 completely surrounds the spilled liquid or preventing, slowing, or minimizing liquids from flowing off of the panel 10 when the at least one liquid-repelling element 22 does not completely surround the spilled liquid, but directs or guides the spilled liquid to a predetermined location.

As discussed above, the panel 10 can be incorporated into a cooking appliance, such as a bottom surface of an oven or as a cooktop, wherein the cooktop can be a gas cooktop, an electric cooktop, or an induction cooktop. Accordingly, the current technology also provides a cooking appliance comprising the panel 10.

The current technology further provides a method of preparing or fabricating a panel, such as the panel 10 described above. The method comprises disposing a precursor solution directly onto a surface of a substrate in a pattern defined by a single line. The pattern can be a continuous geometric pattern or a discontinuous geometric pattern. The precursor solution comprises a polymer precursor, such as monomers capable of forming the polymeric matrix described above or the polymeric matrix itself, the graphene nanoparticles or nanosheets discussed above, and a solvent, such as organic solvents known in the art, including paraffinic, isoparaffinic, naphthenic, or aromatic hydrocarbon solvents, and combinations thereof, including toluene, cyclohexane, hexane, heptane, octane, nonane, isooctane, ethylbenzene, isopentane, and the like. The thermoplastic polymer used is a long-chain molecule held together by relatively weak van der Waals forces (relative to covalent or ionic bonds), but the chemical valency bond along the chains is extremely strong. Therefore, the resulting thermoplastic polymer has a high strength and stiffness derived from the inherent properties of the corresponding monomer units and a very high molecular weight. The resulting thermoplastic polymer is amorphous, having a random structure with a high level of molecular entanglement. The polymeric matrix is crystalline, i.e., has a high degree of molecular order and/or alignment.

Next, the method comprises polymerizing the polymer precursor by activating a catalyst and/or heating the substrate and the precursor solution to a temperature of greater than or equal to about 200° C. to less than or equal to about 300° C. or greater than or equal to about 230° C. to less than or equal to about 260° C. for a time period of greater than or equal to about 5 minutes to less than or equal to about 2 hours (or longer), greater than or equal to about 10 minutes to less than or equal to about 1 hour, or greater than or equal to about 15 minutes to less than or equal to about 45 minutes. By removing the at least a portion of the solvent from the precursor solution, the liquid-repelling films are created on the surface in the pattern.

In some aspects, the method also comprises incorporating the panel into a cooking appliance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of fabricating a panel, the method comprising the steps of:
disposing a precursor solution directly onto a surface of a substrate in a pattern defined by a single line, the precursor solution comprising a polymer precursor and graphene nanoparticles;
heating the substrate and the precursor solution;
creating a liquid-repelling film comprising the graphene nanoparticles embedded within a polymeric matrix derived from the polymer precursor, the liquid-repelling film having the pattern from the precursor solution on the surface of the substrate; and
forming the panel,
wherein the liquid-repelling film exhibits a water contact angle of greater than or equal to about 160° and a water sliding angle of less than or equal to about 3°.

2. The method according to claim 1, wherein the pattern is a frame that extends about the periphery of the substrate.

3. The method according to claim 1, wherein the substrate comprises at least one heating element region.

4. The method according to claim 1, further comprising the step of:
incorporating the panel into a cooking appliance.

5. The method according to claim 1, wherein the substrate comprises a glass, a ceramic, or a glass ceramic.

6. The method according to claim 1, wherein the graphene nanoparticles comprise less than or equal to about ten layers of graphene.

7. The method according to claim 1, wherein the graphene nanoparticles comprise a single sheet of graphene.

8. The method according to claim 1, wherein the liquid-repelling film further comprises a polymeric matrix that carries the graphene nanoparticles.

9. The method according to claim 1, wherein the liquid-repelling film is superhydrophobic.

10. The method according to claim 1, wherein the pattern is a continuous pattern defining a circle, an oval, or a polygon.

11. The method according to claim 1, wherein the pattern is disposed about a periphery of the substrate.

12. The method according to claim 1, wherein the panel defines a cooktop surface.
